(19) United States
(12) Patent Application Publication
(10) Pub. No.: US 2009/0200754 A1
(43) Pub. Date: Aug. 13, 2009

(54) FLAT GASKET, ESPECIALLY A CYLINDER HEAD GASKET

(76) Inventors: Peter Schenk, Hohenstein (DE); Ulrich Werz, Dettingen (DE); Tobias Gruhler, Pfullingen (DE)

Correspondence Address: Lipsitz & McAllister, LLC, 755 MAIN STREET, MONROE, CT, 06468, US

(21) Appl. No.: 11/919,359

(22) PCT Filed: Apr. 25, 2006
(86) PCT No.: PCT/EP2006/003805

§ 371 Date: Apr. 8, 2009

(30) Foreign Application Priority Data
Apr. 28, 2005 (DE) 10 2005 019 689.6

(51) Int. Cl. F16J 15/08; F02F 11/00

(52) U.S. Cl. 277/595; 277/590

(57) ABSTRACT

The invention relates to a flat gasket with a gasket sheet having a plurality of passages. The gasket sheet comprises at least one first sheet metal layer which has at least on one side at least one elongate elevation with an elongate base formed out of the sheet metal layer. The base, under maximum stress occurring during installation of the gasket and in machine operation, is stable with respect to the height thereof in at least first longitudinal sections. The flat gasket is particularly useful for cases where machine part sealing surfaces between which the flat gasket is to be inserted do not have the component elasticity required for a reliable seal. The gasket sheet has at least one second sheet metal layer which has a height-elastic bead in the area of the base which, together with the base, forms a thickness-elastic area of the flat gasket.

The invention relates to a flat gasket comprising a gasket plate incorporating a plurality of passage openings for sealing a seal gap bounded by the seal surfaces of machine components (e.g. the seal surfaces of a cylinder head and an engine block), wherein the gasket plate comprises at least one first sheet metal layer which, on at least one side thereof, has at least one elevated portion that is elongate in a plan view of the flat gasket and includes a crest provided for pressing against at least one seal surface of a machine component, and wherein the elevated portion has an elongate base body formed out from the first sheet metal layer, the material of said base body being constituted in such a manner and the cross section thereof being configured in such a manner that the base body is pressure and creep-resistant and is thus not deformable in height in at least a first longitudinal section thereof and preferably over the whole or virtually the whole length of the base body under the maximum load occurring during the installation of the flat gasket as well as during operation of the machine.

Such flat gaskets in the form of cylinder head gaskets are known from DE-103 24 667-A1 as well as from the EP-0 485 693-B1 which is dealt with in this document.

In the following, the invention is discussed on the basis of a cylinder head gasket, although the subject matter of the invention could also be another type of flat gasket, for example, an exhaust manifold gasket.

The cylinder head gasket described in EP-0 485 693-B1 includes a one-piece metallic gasket plate the design of which is based on the following considerations; For the functioning of a cylinder head gasket, the engine block (crank case) and the cylinder head cannot be regarded as absolutely rigid components; rathermore, the tightening of the cylinder head bolts and the changing gas pressures in the combustion chambers lead to flexure of these engine components, i.e. in the long run, this leads to the seal gap that is bounded by the seal surfaces of the engine components and accommodates the cylinder head gasket not retaining the shape of a thin, plane-parallel plate. In addition, the locally different thermal expansions of the engine block and the cylinder head when the engine is in operation (this also occurring in the axial direction of the combustion chambers) and also the locally different component-rigidities of these two engine components at their seal surfaces as well as in the areas bordering on these seal surfaces (due to recesses and cavities in the engine components) have an effect on the topography of the seal surfaces of the engine components bounding the seal gap when the engine is operating. Now the design of the gasket plate of the cylinder head gasket in EP-0 485 693-B1 is based on the basic idea of adapting the shape of the gasket plate of the cylinder head gasket to the topography of the seal surfaces of the engine components in the areas thereof effective for the sealing process such as occur after tightening the cylinder head bolts, i.e. after the mounting of the cylinder head gasket, and the resilient deformations of the components that are necessary for the maintenance of the seal when the engine is in operation are not permitted to occur at or in the cylinder head gasket, but rather, on or in the engine components, the engine block and the cylinder head, so that the gasket plate of the cylinder head gasket can be made of a material which is stable, i.e. not deformable in thickness when tightening the cylinder head bolts and during operation of the engine.

Naturally, this basic concept for the design of a cylinder head gasket does not exclude the gasket plate from being provided with a coating which serves for the e.g. so-called micro sealing process and can adapt to the surface roughness of the seal surfaces of the engine components; such a coating can be of a synthetic material or could be a coating of another material, e.g. it could also consist of a metal.

Now, there are cases wherein cylinder head gaskets are used in which a cylinder head gasket of the type mentioned hereinabove incorporating a gasket plate which can be regarded as rigid does not lead to optimal results; in the case of a reciprocating piston internal combustion engine incorporating a so-called chain case, the latter is frequently formed by a chain case lower part bordering on the engine block and a chain case upper part bordering on the cylinder head, whereby one of the two parts could also be formed on the neighbouring component, the engine block or the cylinder head; the seal gap is then bounded by the engine block, the cylinder head and at least one chain case part. If the cavity of the chain case is also to be totally or partly sealed by the cylinder head gasket, then this also extends over at least a portion of the chain case part that is manufactured as a separate component. It is not rare however, that, as a consequence of manufacturing tolerances, the seal surface of the chain case part that was manufactured as a separate component and which faces the cylinder head gasket is not exactly flush with the adjacent seal surface of the engine block or the cylinder head after the assembly thereof so that the seal gap which is to be sealed by the cylinder head gasket has a step-like widening or narrowing at the joint between the chain case part and the engine block or the cylinder head and can only be sealed with difficulty by means of a cylinder head gasket comprising a rigid gasket plate—if, for example, manufacturing tolerances lead to the seal gap being narrower in the vicinity of the chain case than it is between the engine block and the cylinder head, a cylinder head gasket comprising a rigid gasket plate can lead to the specific surface pressures between the cylinder head gasket and the engine block on the one hand and the cylinder head on the other in the portion of the seal gap located between the engine block and the cylinder head being insufficient, at least in certain places, to produce a reliable sealing effect under all operating conditions. If a cylinder head gasket of the type mentioned hereinabove has a plurality of relatively closely adjacent passage openings which are to be sealed with respect to one another and in relation to the environment by a plurality of approximately strip-like or linear elevated portions of the cylinder head gasket that abut one another or merge into one another, then the system consisting of the cylinder head gasket and the seal surfaces of the engine components can sometimes be statically over-specified in such a region and lead to a deficient sealing effect. In addition, permanent deformations of the engine block seal surface can occur in those regions of the engine block in which the cylinder head bolts engage, and this can likewise lead to problems, in particular, when replacing the cylinder head gasket, when using an exchange seal comprising a rigid gasket plate.

These problems can be eliminated or at least reduced with the cylinder head gasket described in DE-103 24 667-A1, namely, in that in the case of a seal of the type mentioned hereinabove such as is disclosed in DE-103 24 667-A1, the base body or the base bodies also have longitudinal sections which are deformable in height in plastic manner, possibly also, resiliently to a small extent, under the load arising when mounting the seal as well as in operation thereof, be it because the base body is differently dimensioned in such a longitudinal section and/or has a different cross section than in the longitudinal sections that are not deformable in height, or because the base body possesses other material properties in the longitudinal sections that are deformable in height than in the longitudinal sections which are not deformable in height. In consequence, the cylinder head gasket described in DE-103 24 667-A1 can adapt to alterations in the topography of the seal surfaces of the engine components within selected regions, alterations which can occur when tightening the cylinder head bolts, i.e. when mounting the cylinder head gasket, and/or during the first warming of the engine, and also possibly during an initial period of operation of the engine; furthermore, such a cylinder head gasket is, if necessary, in a position to compensate for manufacturing tolerances and adapt to long term alterations of the seal surfaces of the engine components that were caused whilst the engine was in operation, and especially when installing a replacement seal.

From the above discussion of the state of the art, it is apparent that the known cylinder head gaskets described therein can only reliably fulfil their sealing function if the engine components between which such a cylinder head gasket is clamped have an overall component elasticity in the region of the elevated portions of the gasket plate which is such that, despite the locally different thermal expansions and the changing gas pressures in the combustion chambers, the seal surfaces of the engine components are always pressed against the cylinder head gasket with at least the specific surface pressure required for the sealing process when the engine is in operation, namely, against the crests of the elevated portions when the gasket plate is provided with elevated portions serving for the sealing function on both sides thereof, or against the crests of the elevated portions as well as against the surface portions of the gasket plate opposite the elevated portions when said gasket plate is only provided with such elevated portions on one side thereof.

However, it has now been shown that there are operational fields for flat gaskets of the type under discussion wherein the machine parts do not have the requisite component elasticity at every point where this is necessary to achieve reliable sealing with the help of such a flat gasket.

Consequently, the object of the invention is to provide a flat gasket of the type mentioned hereinabove such as is disclosed in particular in DE-103 24 667-A1 which can reliably fulfil its sealing function even if the machine parts, between which the flat gasket is to be clamped, do not have the requisite component elasticity to provide reliable functioning of the machine in those regions or in a part of these regions between which the elevated portion or the elevated portions of the gasket plate lie when the flat gasket is in position.

In accordance with the basic concept of the solution in accordance with the invention, this object is a deviation from the principle of the known, at least substantially pressure resistant, single layered flat gaskets with supporting elevated portions which are not deformable in height or are at most only slightly deformable in height in certain sections and in a substantially plastic manner even during operation of the machine, and it is proposed that the gasket plate of the known flat gaskets be supplemented by at least one second sheet metal layer which has at least one bead that is deformable in height in a springy-resilient manner in the region of an elevated portion or the elevated portions of the first sheet metal layer (as seen in a plan view of the gasket plate), so that the elevated portion and the bead together form a thickness-resilient region of the flat gasket.

In particular in the case of a cylinder head gasket, sliding movements between the flat gasket and the seal surfaces of the machine components (in particular, the engine block and the cylinder head) between which the flat gasket is clamped can arise during operation of the machine, i.e. when the engine is operating, that is to say, relative movements running parallel to the plane defined by the flat gasket which can also lead to wearing of the flat gasket. The characterisation of the base body or the base bodies of the flat gasket in accordance with the invention as not being deformable in height does not therefore exclude the height or the thickness of a base body being decreased by frictional wear during operation of the machine.

Even if the preferred embodiments of the flat gasket in accordance with the invention are those wherein the base body or the base bodies is or are not deformable in height overall under the maximum load arising during installation of the flat gasket and in operation of the machine, a base body of a flat gasket in accordance with the invention can be produced as regards the material and cross section thereof in such a manner as to be deformed in plastic manner in those regions in which the highest specific surface pressures arise when the flat gasket is in position and during operation of the machine, or everywhere to a slight extent even though to different degrees. Consequently, it is to be understood that a base body or a base body section which is at least substantially pressure and creep-resistant and is thus not deformable in height under operational conditions also includes a base body or a base body section the height of which(even overall in some circumstances) decreases slightly under operating conditions due to a plastic deformation, namely, by locally differing amounts on the one hand and at most by 50 μm on the other, but better, by at most 20 μm and advantageously, by a significantly smaller amount, namely, at most 10 μm.

In this connection, it is pointed out that an important feature of the invention is to be seen in the fact that the base body or the base bodies of a flat gasket in accordance with the invention is or are not resiliently deformable in the height thereof at least in areas thereof, but preferably everywhere, under the dynamic loads arising during the operation of the machine. Hereby, one must take into consideration that no metallic article can be regarded as being absolutely rigid, but rather, always exhibits an unavoidable even though minimal resilient deformation behaviour, and possibly also a plastic deformation behaviour; such an inevitable deformation behaviour should not therefore be excluded by the definition of the present invention.

The second sheet metal layer can extend over the whole or over only a part of the gasket plate—in the latter case, a plurality of second sheet metal layers can also be provided with beads which are arranged close to one another (although possibly spaced from each other) above or below the first sheet metal layer. Naturally, if the component elasticity of the machine parts is adequate in some places but is inadequate in other places, then it also suffices to provide such a bead or such beads just for that elevated portion or those elevated portions or that longitudinal section or those longitudinal sections of the base body or the base bodies where the component elasticity of the machine parts is not sufficient.

The type of flat gaskets affected by the present invention could of course comprise a gasket plate in the conventional sense, but equally however, it is also possible to provide a plurality of flat gasket segments on which elevated portions and beads are provided, and to interconnect the seal segments by connecting webs or the like so that a skeleton-like structure ensues.

Even if the previous discussion alluded to the flat gasket in accordance with the invention having elongate elevated portions with a crest that is provided for pressing against at least one seal surface of a machine component, it follows from this formulation that not all the regions of the gasket plate which are pressed when the flat gasket is in position have to have the shape of such elongate elevated portions.

A flat gasket in accordance with the invention may have one or more of the aforementioned base bodies which can be separated from each other or connected to one another in one piece manner.

In preferred embodiments of the flat gasket in accordance with the invention, the elevated portion or elevated portions of the first sheet metal layer and the bead or beads of the second sheet metal layer serve for sealing around one or more passage openings in the gasket plate; however, the elevated portion or elevated portions, possibly together with the bead or beads, can, at least in places, also have the function of pure supporting elements, by virtue of which surface distortions of one of the machine parts or of both machine parts are prevented or at least minimized within certain regions of the latter when the flat gasket is in position, such as can be desirable for example, in the case of a cylinder head for a multi-cylinder engine in the vicinity of the longitudinal ends of the cylinder head.

By virtue of a flat gasket in accordance with the invention, not only can the posed object be achieved, but yet a further advantage can also be obtained: In particular in the case of cylinder head gaskets but frequently also in the case of other flat gaskets such as exhaust manifold gaskets for example, the engine manufacturer specifies a certain breadth (width) for the seal gap that is to be sealed by the flat gasket. Moreover, in the case of metallic flat gaskets, it is often desirable to provide around a passage opening that is to be sealed, a ring-like sealing element surrounding said passage opening, this being effected in that a sheet metal layer is raised around the edge of this passage opening, i.e. a boundary region of the sheet metal layer adjoining the passage opening is folded back on itself in order to produce around the passage opening an increased pressing action between the flat gasket and the seal surfaces of the machine components accommodating said gasket therebetween. Now, however, in the case of a single layer metallic flat gasket such as is described in EP-0 485 693-B1 or DE-103 24 667-A1 for example, a given seal gap width of more than 1.5 mm necessitates the thickness of the sheet metal layer to be so large that a bead produced in this sheet metal layer by a stamping process, a base body in the form of a rectangular bead such as is described and illustrated in DE-103 24 667-A1 for example, must, because of the given installation thickness, have such a height and consequently for technical reasons such a width that the space available in a flat gasket e.g. that between two neighbouring passage openings, for the thus resulting width of bead is not sufficient. Due to the fact that the second sheet metal layer is provided for a flat gasket in accordance with the invention, then even for a relatively large width of the seal gap, a thinner metal sheet can be used for the first sheet metal layer that is provided with the base body or the base bodies than is the case for the known cylinder head gaskets in accordance with EP-0 485 693-B1 and DE-103 24 667-A1, with the consequence that beads of relatively small width can be produced in both sheet metal layers of the flat gaskets in accordance with the invention, namely height resilient beads in the second sheet metal layer and rectangular beads forming base bodies that are at least substantially not deformable in height in the first sheet metal layer. Moreover, the comparatively small sheet thickness of the first sheet metal layer of a flat gasket in accordance with the invention makes it possible to fold back this first sheet metal layer upon itself around a passage opening that is to be sealed for the purposes of forming a sealing element, without this thereby resulting in the total thickness of the flat gasket being too large in this region in the light of the prescribed width for the seal gap.

Since, in a flat gasket in accordance with the invention, all those regions of the first sheet metal layer which are intended to accommodate compressive forces when the flat gasket is in position should not, at least predominantly, be deformable in height, whereas the bead or beads of the second sheet metal layer should be deformable in height in a springy-resilient manner, the embodiments to be recommended are those wherein the sheet thickness of the first sheet metal layer is greater than that of the second sheet metal layer.

For the second sheet metal layer, a metal sheet consisting of a high-strength steel having resilient properties (referred to as a spring steel sheet in the following) is to be preferred, but it is also possible to use another steel sheet for the second sheet metal layer, this only having springy-resilient properties in the beaded region e.g. due to it being subjected to heat treatment by means of a laser.

In order to enable the base body or the base bodies in a flat gasket in accordance with the invention to be produced by a process of forming the first sheet metal layer and for the base body to exhibit the requisite stability, preferred embodiments of the flat gasket in accordance with the invention are characterised in that the first sheet metal layer consists of an easily workable steel which is cold worked in the base body region due to said base body being stamped out from the sheet metal layer.

The bead or the beads of the second sheet metal layer may be a so-called full bead or a so-called half bead, whereby the full bead has a cross section which is approximately in the form of a circular arc whilst the half bead is approximately in the shape of a step or offset having a region running at an angle to the plane of the layer.

In order to enable the load-bearing regions of the flat gasket in accordance with the invention, i.e. those regions which are pressed when the flat gasket is in position, to adapt as much as possible to the seal surfaces of the machine components bounding the seal gap, it is of advantage if the crest of the elevated portion or the crests of the elevated portions has or have a height profile along the elevated portion or along the elevated portions which is formed, prior to the installation of the flat gasket, at least approximately in accord with the topography of the seal gap that is to be sealed by the flat gasket and results when the flat gasket is clamped between the seal surfaces of the machine components.

Above all then, if, in the case of a flat gasket in accordance with the invention, we are concerned with a cylinder head gasket, it is recommendable that the gasket plate be provided with a coating of synthetic material at least in the region of the crest of the at least one elevated portion, whereby said coating is e.g. a coating which is suitable for preventing leakages resulting from the surface roughness of a seal surface of a machine component or the seal surfaces of machine components.

Further features, details and advantages of the invention are apparent from the following description and the accompanying graphical illustration of a plurality of particularly advantageous embodiments of the flat gasket in accordance with the invention; in the drawing:

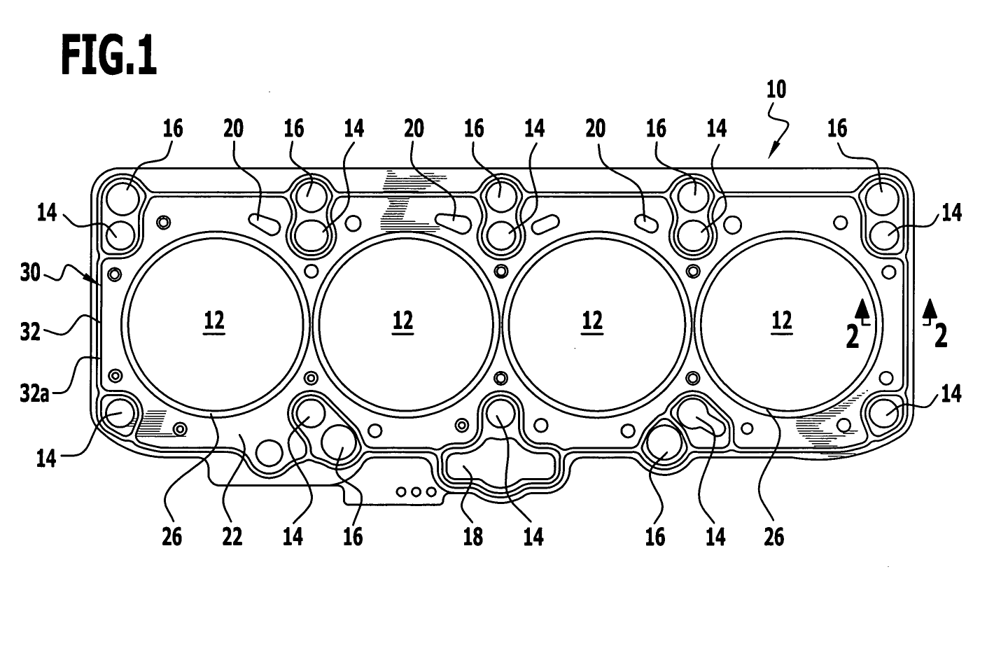

FIG. 1 shows a schematic plan view of a flat gasket in accordance with the invention in the form of a cylinder head gasket;

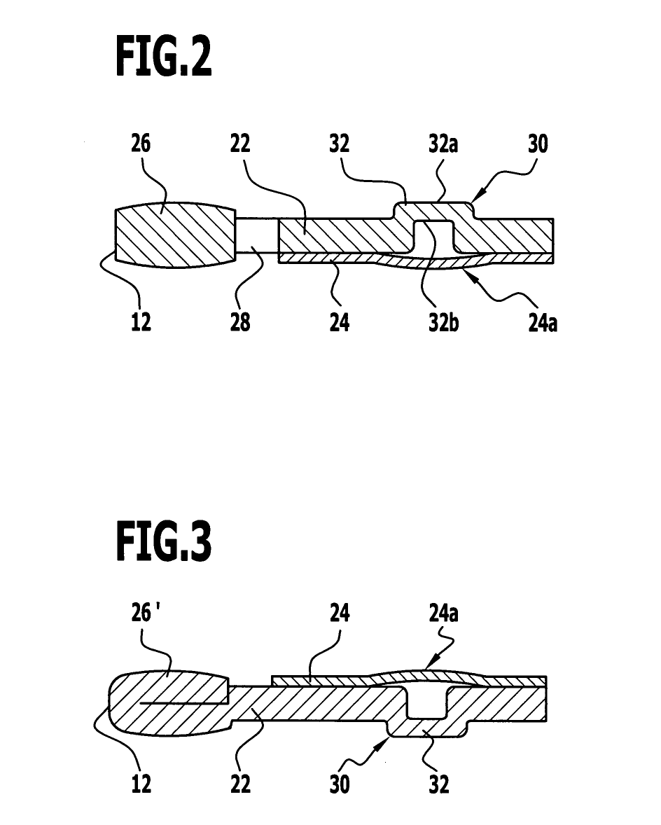

FIG. 2 a section through a part of this cylinder head gasket in correspondence with the line 2-2;

FIG. 3 an illustration corresponding to FIG. 2 of a second embodiment;

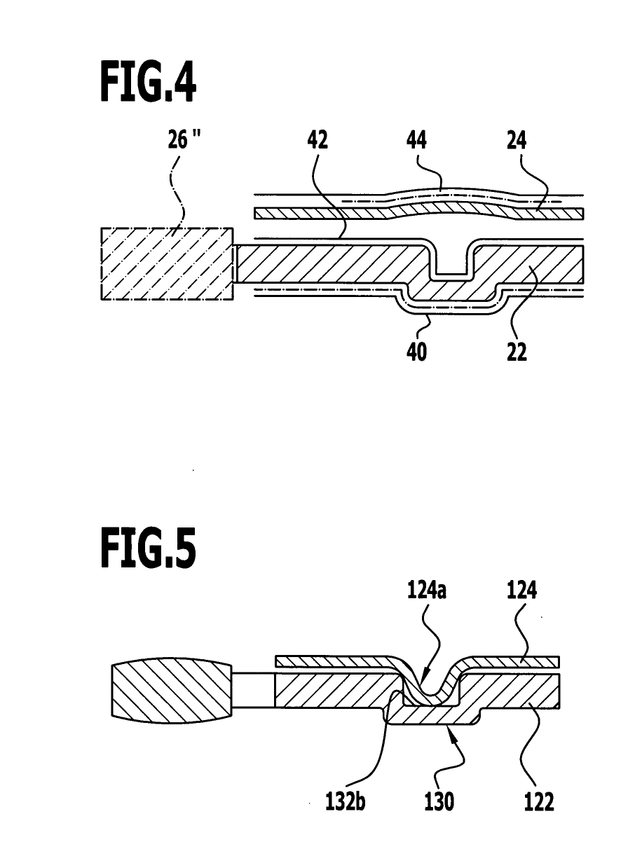

FIG. 4 a variant of the embodiment illustrated in FIG. 3, wherein the two sheet metal layers of the gasket plate are shown spaced from each other in order to increase the clarity of the illustration, and

FIGS. 5 to 7 three further embodiments which merely show in sectional form the region of a flat gasket concerned with the present invention.

In the plan view of a cylinder head gasket in accordance with the invention that is illustrated in FIG. 1, only the upper of the two sheet metal layers of the gasket plate of this cylinder head gasket is visible, and this sheet metal layer is that one which is provided with the base bodies formed out from the sheet metal layer.

This cylinder head gasket has a gasket plate bearing the general reference 10 in which there are formed combustion chamber openings 12, bolt holes 14 for the entry of cylinder head bolts, oil holes 16 for the passage of pressurised oil, an oil hole 18 for the returning oil as well as various water holes 20 for the passage of a cooling agent.

As is apparent from FIGS. 1 and 2, the gasket plate 10 comprises a first sheet metal layer 22 of relatively large sheet thickness and a second sheet metal layer 24 of lesser sheet thickness which lies close against the lower surface of the first sheet metal layer 22. The first sheet metal layer 22 consists of a steel sheet which can be formed by a stamping process and extends over the entire gasket plate 10. Solid circular combustion chamber sealing elements 26 each of which surrounds one of the combustion chamber openings 12 are connected to the first sheet metal layer 22 via e.g. webs 28 that are not visible in FIG. 1; these combustion chamber sealing elements 26 consist of a pressure resistant steel and the thickness thereof is such that the highest specific surface pressures (compressive force per unit area) will occur around the combustion chamber openings 12 in the region of the combustion chamber sealing elements 26 when the cylinder head gasket is clamped between a cylinder head and an engine block.

Skid-like base bodies 30 having an approximately U-shaped cross section are formed out of the first sheet metal layer 22 by means of a stamping process, these bodies forming elongate elevated portions 32 protruding above the actual first sheet metal layer 22 and comprising flat crests 32a which are pressed against a seal surface of the cylinder head or the engine block when the cylinder head gasket is in position. The base bodies 30 comprise grooves 32b opposite the crests 32a.

The material of the first sheet metal layer 22 is cold worked in the course of forming the elevated portions 32 and the process of stamping in the grooves 32b that is inherent thereto, and the cross section of the base bodies 30 is dimensioned in such a way that, by taking into consideration the rigidity of the material of the first sheet metal layer 22, the resulting elevated portions 32 in the region of the base bodies 30 are pressure and creep-resistant and thus not deformable in height over at least the greater part of the length of the base bodies 30 under the maximum pressure load arising during the installation of the cylinder head gasket as well as in operation of the engine.

The second sheet metal layer 24 consists of a spring steel metal sheet and is provided with beads 24a at least in the region of one or more of the base bodies 30, and preferably in the region of all the base bodies 30, these beads being so-called full beads which extend along the base bodies 30 and bridge the grooves 32b therein, whereby the bead feet (by this, one is given to understand the two lateral edges of a bead where they merge into the adjacent flat regions of the sheet metal layer) are supported on the first sheet metal layer 22 on both sides of a groove 32b. The summit of the bead thus faces the crest 32a of the elevated portion 32.

In like manner to the first sheet metal layer 22, the second sheet metal layer 24 can extend over the whole gasket plate 10 and have a bead 24a at every point where the first sheet metal layer 22 is provided with a base body 30 that is formed out therefrom. However, in place of a single second sheet metal layer 24, this could be replaced by a plurality of mutually spaced segments of such a second sheet metal layer which are arranged next to one another on the first sheet metal layer 22 and are either separated from each other or interconnected by webs. Moreover, cases are conceivable in which a bead 24a or a region of a second sheet metal layer is not assigned to all the base bodies 30.

It is to be assumed for FIGS. 1 and 2 that the crests 32a of the elevated portions 32 rest against the seal surface of the cylinder head and the beads 24a against the seal surface of the engine block when the cylinder head gasket is in position.

However, in dependence on the materials of the cylinder head and the engine block, it can be advantageous if the beads 24a rest against the seal surface of the cylinder head and the crests 32a against the seal surface of the engine block. This is intended to be the case for the variant illustrated in FIG. 3. In FIG. 3, the same reference symbols have been used as in FIG. 2 with the exception of the reference symbol 26′ for the combustion chamber sealing element of the embodiment illustrated in FIG. 3, wherein the combustion chamber sealing element 26′ has been obtained by a process of forming the first sheet metal layer 22, namely in that a boundary region of the first sheet metal layer 22 surrounding a combustion chamber opening 12 has been folded back on itself and then shaped by a compression moulding process as can be perceived from FIG. 3.

Now as can be seen from FIG. 1, this can be interpreted as though just a single base body 30 had been formed out from the first sheet metal layer 22, this said body forming a single, closed, but partially branching linear path; in accordance with another interpretation however, the first sheet metal layer 22 is provided with a plurality of base bodies 30 which merge into one another i.e. the crests 32a thereof form an uninterrupted approximately linear seal surface which branches out in certain places. In each case, all the oil holes 16, 18, together partly with the bolt holes 14, are surrounded in closed manner by base bodies or base body sections, whilst the water holes 20 are enclosed between the combustion chamber sealing elements 26 and the base bodies 30 or the base body sections (and naturally also between the seal surfaces of the engine block and the cylinder head) when the cylinder head gasket is in position.

In FIG. 4, the same reference symbols were used as in FIG. 3 with the exception of the reference symbol 26″ for a merely schematically indicated combustion chamber sealing element. In FIG. 4, in contrast to what happens in reality, the second sheet metal layer 24 is illustrated as being spaced from the first sheet metal layer 22 in order to enable the following detail to be clearly depicted in the drawing: In the embodiment illustrated in FIG. 4, the first sheet metal layer 22 has a respective coating of synthetic material 40 and 42 on both sides thereof, whilst the second sheet metal layer 24 is provided with a coating 44 on only one side thereof, namely, on that side which is located on one of the outer surfaces of the gasket plate 10. These coatings may be single or multi-layer coatings, for which materials are used such as are generally used for the coating of sheet metal layers of metallic cylinder head gaskets. Such coatings can serve to provide a so-called micro sealing effect in order to fill out surface roughness in the seal surfaces of the cylinder head and the engine block. In the case of multi-layer metallic flat gaskets however, a coating can also serve to provide better sealing between mutually adjacent sheet metal layers in the interior of the flat gasket. Finally, such a coating can also serve as a corrosion prevention means or form a glide layer in order to prevent frictional wear between the flat gasket and the seal surfaces of the machine parts including said flat gasket therebetween when the machine is in operation.

The same reference symbols as were used in FIGS. 1 and 2 are used in FIGS. 5 to 7, although they are respectively increased by 100 and 200 and 300.

In the embodiment illustrated in FIG. 5, a full bead 124a of the second sheet metal layer 124 engages in the groove 132b in the base body 130, whereby the dimensional relationships are designed to be such that the summit of the bead 124a is pressed against the base or the bottom of the groove 132b by pre-loading the bead 124a in the vertical direction, whilst the two bead feet of the bead 124a are pressed against the seal surface of the engine block or the cylinder head when the cylinder head gasket is in position.

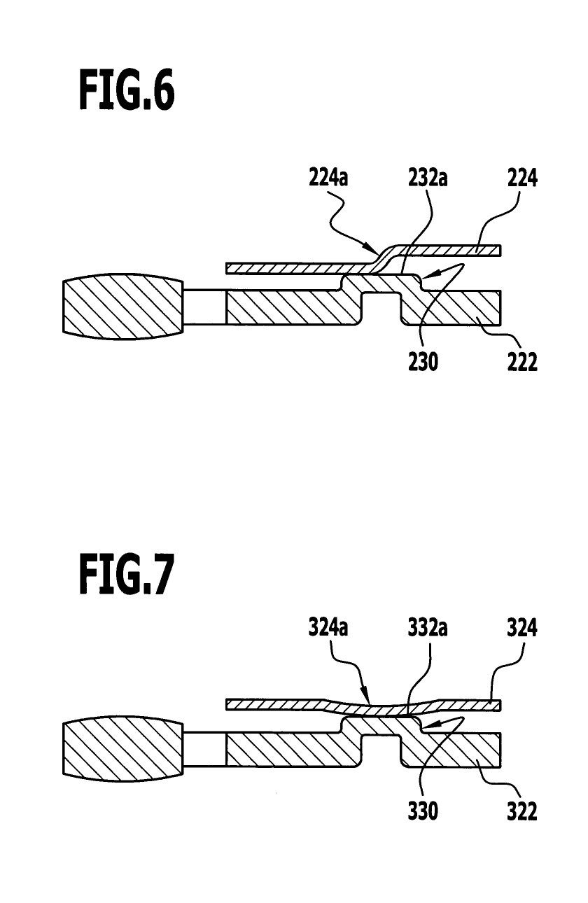

In the embodiment in accordance with FIG. 6, a so-called half bead 224a is formed in the second sheet metal layer 224, this bead being supported on the crest 232a of the base body 230 when the cylinder head gasket is in position.

The embodiment illustrated in FIG. 7 differs from that in accordance with FIG. 6 only in that a full bead 324a is used in place of the half bead 224a, the crest thereof being supported on the crest 332a of the base body 330.

1-21. (canceled)

22. A flat gasket comprising:
a gasket plate incorporating a plurality of passage openings for sealing a seal gap bounded by the seal surfaces of machine components, wherein:
the gasket plate has at least one first sheet metal layer which, on at least one side thereof, comprises at least one elevated portion that is elongate in a plan view of the flat gasket and includes a crest that is subjected to a compressive force when the flat gasket is clamped between the seal surfaces of the machine components,
the elevated portion has an elongate base body formed out from the first sheet metal layer, the material of said base body being constituted in such a manner and the cross section thereof being configured in such a manner that the base body is inelastic and at least substantially pressure and creep-resistant and thus not deformable in height in at least first longitudinal sections of the base body under the maximum load occurring during the installation of the flat gasket as well as during operation of the machine, and
the gasket plate has at least a second sheet metal layer which in the region of the base body comprises a bead which is deformable in springy-resilient manner with respect to the height thereof in such a way that the elevated portion and the bead together form a thickness-resilient region of the flat gasket,
the crest of the elevated portion of the first sheet metal layer being located on an outer surface of the gasket plate.

23. A flat gasket in accordance with claim 22, wherein the sheet thickness of the first sheet metal layer is greater than that of the second sheet metal layer.

24. A flat gasket in accordance with claim 22, wherein the second sheet metal layer is a sheet metal layer consisting of a high-strength steel having resilient properties.

25. A flat gasket in accordance with claim 22, wherein the first sheet metal layer consists of a deformable steel which is cold worked in the base body region due to the base body being stamped out from the first sheet metal layer.

26. A flat gasket in accordance with claim 22, wherein the second sheet metal layer extends over the whole gasket plate.

27. A flat gasket in accordance with claim 22, wherein the bead is in the form of a full bead.

28. A flat gasket in accordance with claim 22, wherein the crest has a height profile along the elevated portion which is formed, prior to the installation of the flat gasket, at least approximately in correspondence with the topography of the seal gap that is to be sealed by the flat gasket and results when the flat gasket is clamped between the seal surfaces of the machine components.

29. A flat gasket in accordance with claim 22, wherein the second sheet metal layer is arranged on the side of the first sheet metal layer opposite the crest of the elevated portion.

30. A flat gasket in accordance with claim 29, wherein the bead in the form of a full bead protrudes in a direction away from the first sheet metal layer, and has bead feet which lie on both sides of the base body outside the base body in a plan view of the flat gasket.

31. A flat gasket in accordance with claim 29, wherein:
the first sheet metal layer on the side thereof opposite to the crest of the elevated portion comprises a groove in the region of the base body in which the bead in the form of a full bead engages in such a manner that the convex side of the bead is pressed against the bottom of the groove when the flat gasket is in position and compressed, and
bead feet of the bead lie on both sides of the groove outside the groove in a plan view of the flat gasket.

32. A flat gasket in accordance with claim 22, wherein:
the second sheet metal layer is arranged on that side of the first sheet metal layer on which the elevated portion is located, and
the bead is supported on the crest of the elevated portion when the flat gasket is in position and compressed.

33. A flat gasket in accordance with claim 32, wherein the convex side of the bead in the form of a full bead is supported on the crest of the elevated portion when the flat gasket is in position and compressed.

34. A flat gasket in accordance with claim 22, wherein the gasket plate has at most two sheet metal layers at every point thereof.

35. A flat gasket in accordance with claim 22, wherein the gasket plate is provided with a coating at least in the region of the crest of the at least one elevated portion.

36. A flat gasket in accordance with claim 22, wherein the flat gasket is in the form of a cylinder head gasket.

37. A flat gasket in accordance with claim 22, wherein the bead extends along the base body over the entire length thereof.

38. A flat gasket in accordance with claim 37, wherein each base body is provided with a bead which extends over the entire length thereof.

39. A flat gasket in accordance with claim 22, wherein the base body completely surrounds a passage opening or a plurality of passage openings together.

40. A flat gasket in accordance with claim 22, wherein the base body and the bead associated therewith form a sealing system surrounding the passage opening in the form of a first sealing system in a radial direction with respect to the passage opening.

41. A flat gasket in accordance with claim 22, wherein the second sheet metal layer is not deformable in a plastic manner under the maximum load arising during the installation of the flat gasket and that occurring in operation of the machine.

42. A flat gasket in accordance with claim 22, wherein the flat gasket is a cylinder head gasket.
